(19) United States
(12) Patent Application Publication
(10) Pub. No.: US 2011/0221503 A1
(43) Pub. Date: Sep. 15, 2011

(54) SEMICONDUCTOR INTEGRATED CIRCUIT INCLUDING CONSTANT ADJUSTING CIRCUIT

(75) Inventor: Yoshitaka OKA, Kanagawa (JP)

(73) Assignee: RENESAS ELECTRONICS CORPORATION, Kanagawa (JP)

(21) Appl. No.: 13/043,146

(22) Filed: Mar. 8, 2011

(30) Foreign Application Priority Data
Mar. 9, 2010 (JP) 2010-051618

(51) Int. Cl. G06G 7/184

(52) U.S. Cl. 327/337

(57) ABSTRACT

A semiconductor integrated circuit includes an integrating circuit comprising a variable resistance, an integration capacitance and an amplifier; a switched capacitor connected with the amplifier in parallel to the variable resistance; and an adjusting circuit configured to adjust a resistance value of the variable resistance. The integrating circuit generates a control signal of a voltage based on a first time constant determined based on the resistance value of the variable resistance and a capacitance value of the integration capacitance, and a second time constant determined based on a capacitance value of the switched capacitor and the capacitance value of the integration capacitance. The adjusting circuit adjusts the resistance value of the variable resistance based on the control signal.

### INCORPORATION BY REFERENCE

This patent application claims a priority on convention based on Japanese Patent Application No. 2010-51, 618 filed on Mar. 9, 2010. The disclosure thereof is incorporated herein by reference.

### TECHNICAL FIELD

The present invention relates to a time constant adjusting circuit and a time constant adjustment method using the same, and in particular relates to a time constant adjusting circuit having a variable resistance and a time constant adjustment method using the same.

A value RC as a product of a value of a resistance R and a value of a capacitance C is called a time constant. The time constant is used for a method of setting a cut-off frequency of a filter, and a larger time constant is associated with a longer period of time. By setting optional values of the resistance R and the capacitance C, the time constant can be set in the circuit.

Here, variations in the values of the resistance R and the capacitance C are directly related to accuracy of the time constant set in the circuit. In general, variations in the resistance and the capacitance prepared outside an integrated circuit are within several percent, but variations in the resistance and capacitance formed in the integrated circuit are about 15%. In the latter case, a variation of the time constant as a product of the resistance and the capacitance will reach 30%, and a cut-off frequency in a filter in the above example is varied to cause degradation of circuit characteristic.

In conjunction with the above description, Patent Literature 1 (JP H10-322162A) discloses a technique related to a time constant adjusting circuit. The time constant adjusting circuit adjusts a time constant of an electronic circuit in an integrated circuit. The time constant adjusting circuit has a time reference generating section, a time constant generating section, a determining section, and a storage section. Here, the time reference generating section is configured to include a time constant circuit provided outside the integrated circuit, and generates a time reference signal changing with the lapse of time in a time constant of the time constant circuit. The time constant generating section is configured to include a time constant circuit in the integrated circuit and generates a time constant signal changing with the lapse of time in a time constant of the time constant circuit. The determining section determines a time when the time reference signal reaches a predetermined value and a time when the time constant signal reaches the predetermined value. The storage section stores the determination result of the determining section.

The time constant adjusting circuit adjusts the time constant of the electronic circuit based on an output of the storage section.

The time constant adjusting circuit in Patent Literature 1 will be described.

FIG. 1 is a block diagram schematically showing a configuration of the time constant adjusting circuit in Patent Literature 1. The time constant adjusting circuit is provided with a time reference generating section 10, a time constant generating section 20, a determining section 30, a storage section 40 and an electronic circuit 50. It should be noted that a start signal output section (not shown) is connected to the time constant adjusting circuit of FIG. 1.

A connection relation of the respective sections of the time constant adjusting circuit and external elements will be described. The time reference generating section 10 and the time constant generating section 20 are connected to the start signal output section (not shown). The outputs of the time reference generating section 10 and the time constant generating section 20 are connected to the determining section 30. The determining section 30 is connected to the storage section 40. The storage section 40 is connected to the electronic circuit 50.

The time constant adjusting circuit performs a correction so that a time constant of the time constant generating section in the integrated circuit approaches a reference value as a time constant of the time reference generating section that is arranged outside the integrated circuit.

In general, variations of resistance and capacitance arranged externally are within several percent, whereas variations of resistance and a capacitance formed on the integrated circuit are about 15%. Accordingly, a variation of a time constant as the product of R and C will fall in about 30%, thereby causing characteristic degradation such as fluctuation of a cut-off frequency in a filter.

FIG. 2 is a circuit diagram showing a specific configuration example of the time constant adjusting circuit according to Patent Literature 1. The time constant adjusting circuit in FIG. 2 is provided with a time reference generating section 10, a time constant generating section 21, a determining section 31, a storage section 41 and an electronic circuit 51. Here, the time constant generating section 21, the determining section 31, the storage section 41 and the electronic circuit 51 in FIG. 2 correspond to the time constant generating section 20, the determining section 30, the storage section 40 and the electronic circuit 50 in FIG. 1, respectively.

The time reference generating section 10 includes a capacitance 1011, a resistance 1021 and a switch 1031. The time constant generating section 21 includes a capacitance 2111, a resistance 2121 and a switch 2131. The determining section 31 and the storage section 41 include first and second amplifiers 3011 and 3012, a flip-flop 4111 and a power supply Vb1. The electronic circuit 51 includes an input node 5111, an amplifier 5121, first and second capacitances 5131 and 5132, first to sixth resistances 5141 to 5146, first to third switches 5151 to 5153 and a power supply VAG.

One end of the capacitance 1011 is grounded. The other end of the capacitance 1011 is connected to one end of the resistance 1021, one end of the switch 1031 and a non-inversion input of the amplifier 3011. The other end of the resistance 1021 is connected to a power supply Vcc. The other end of the switch 1031 is grounded. The start signal (not shown) is connected to a control input of the switch 1031.

One end of the capacitance 2111 is grounded. The other end of the capacitance 2111 is connected to one end of the resistance 2121, one end of the switch 2131, and a non-inversion input of the amplifier 3012. The other end of the resistance 2121 is connected to the power supply Vcc. The other end of the switch 2131 is grounded. The start signal (not shown) is connected to a control input of the switch 2131.

An inversion input of each of the two amplifiers 3011 and 3012 is connected to the power supply Vb1. Outputs of the two amplifiers 3011 and 3012 are connected to two input terminals of the flip-flop 4111, respectively. An output of the flip-flop 4111 is connected to a control input of each of the three switches 5151 to 5153.

The input node 5111 is connected to one ends of the two resistances 5141 and 5142. The other end of the resistance 5142 is connected to one end of the switch 5151. The other end of the switch 5151 is connected to the other end of the resistance 5141, each one end of the two switches 5152 and 5153, one ends of the two resistances 5143 and 5145, and one end of the capacitance 5132. The other end of the capacitance 5132 is grounded. The other end of the switch 5152 is connected to one end of the resistance 5144. The other end of the resistance 5144 is connected to the other end of the resistance 5143, one end of the capacitance 5131 and the inversion input of the amplifier 5121. The other end of the switch 5153 is connected to one end of the resistance 5146. The non-inversion input of the amplifier 5121 is connected to a power supply VAG. An output of the amplifier 5121 is connected to the other end of the capacitance 5131 and the other ends of the two resistances 5145 and 5146.

Here, the capacitance 1011 and the resistance 1021 are used for generation of a reference time constant. Attention should be paid for the fact that the capacitance 1011 and the resistance 1021 are arranged in order to improve accuracy of a capacitance value and a resistance value, or improve accuracy of the time constant.

FIG. 3 is a circuit diagram showing the configuration of another time constant adjusting circuit according to Patent Literature 1. The time constant adjusting circuit in FIG. 3 is provided with the time reference generating section 10, a time constant generating section 22, a determining section 32, a storage section 42, an electronic circuit 52 and a counter 60. Here, the time constant generating section 22, the determining section 32, the storage section 42 and the electronic circuit 52 in FIG. 3 correspond to the time constant generating section 20, the determining section 30, the storage section 40 and the electronic circuit 50 in FIG. 1, respectively.

The components of the time reference generating section 10 in FIG. 3 are the same as those described above in FIG. 2. The time constant generating section 22 includes a capacitance 2211, n+1 resistances 2221-0 to 2221-n, a switch 2231, and n switches 2231-1 to 2231-n. The determining section 32 and the storage section 42 include the two amplifiers 3011 and 3012, a counter 4211, and the power supply Vb1. The electronic circuit 52 includes an input, an amplifier 5221, a capacitance 5231, m+1 resistances 5241-0 to 5241-m, and m switches 5251-1 to 5251-m.

One end of the capacitance 1011 is grounded. The other end of the capacitance 1011 is connected to one end of the resistance 1021, one end of the switch 1031, and a non-inversion input of the amplifier 3011. The other end of the resistance 1021 is connected to a power supply Vcc. The other end of the switch 1031 is grounded. The start signal is connected to a control input of the switch 1031.

One end of the capacitance 2211 is grounded. The other end of the capacitance 2211 is connected to one end of the resistance 2221-0, one end of the switch 2231, one ends of the n switches 2231-1 to 2231-n, and a non-inversion input of the amplifier 3012. The other ends of the n switches 2231-1 to 2231-n are connected to one ends of the n resistances 2221-1 to 2221-n, respectively. The other end of the resistance 2221-0 and the other ends of the resistances 2221-1 to 2221-n are connected to the power supply Vcc. The start signal is connected to a control input of the switch 2231 and an input of the counter 60. N outputs of the counter 60 are connected to control inputs of the n switches 2231-1 to 2231-n, respectively.

The power supply Vb1 is connected to an inversion input of each of the two amplifiers 3011 and 3012. The two amplifiers 3011 and 3012 are connected to two inputs of the counter 4211, respectively. Control inputs of the m switches 5251-1- to 5251-m are connected to m outputs of the counter 4211, respectively.

The input of the electronic circuit 52 is connected to one ends of the m+1 resistances 5241-0 to 5241-m. The other ends of the m resistances 5241-1 to 5241-m are connected to one ends of the m switches 5251-1 to 5251-m, respectively. The other end of the resistance 5241-0 is connected to other ends of the m switches 5251-1 to 5251-m, one end of the capacitance 5231, and a non-inversion input of the amplifier 5221. An inversion input of the amplifier 5221 is connected to an output of the amplifier 5221.

The time constant adjusting circuit in FIG. 3 adjusts the time constant based on a combination of the plurality of the resistances. At this time, the n+1 resistances and the counter 60 are used in a mode to adjust the time constant, while the other m+1 resistances and the counter 4211 are used in a normal operation mode in which the adjusted time constant is generated. Attention should be paid for the fact that the scale of the integrated circuit is increased as a result.

### CITATION LIST

[Patent Literature 1]: JP H10-322162A

### SUMMARY OF THE INVENTION

In the time constant adjusting circuit according to Patent Literature 1, it is necessary to prepare the time constant generating circuit for reference. The area of a semiconductor chip is increased for the area of the time constant generating circuit. In addition, in the time constant adjusting circuit according to Patent Literature 1, a large-scale circuit which is exclusively used for adjusting a variation of the time constant by using a fine resolution is prepared, thereby resulting in an increase in the layout of an integrated circuit. For these reasons, the time constant adjusting circuit according to Patent Literature 1 is accompanied by increased manufacturing costs.

In an aspect of the present invention, a semiconductor integrated circuit includes: an integrating circuit comprising a variable resistance, an integration capacitance and an amplifier; a switched capacitor connected with the amplifier in parallel to the variable resistance; and an adjusting circuit configured to adjust a resistance value of the variable resistance. The integrating circuit generates a control signal of a voltage based on a first time constant determined based on the resistance value of the variable resistance and a capacitance value of the integration capacitance, and a second time constant determined based on a capacitance value of the switched capacitor and the capacitance value of the integration capacitance. The adjusting circuit adjusts the resistance value of the variable resistance based on the control signal.

In another aspect of the present invention, there is provided a method of adjusting a resistance value of a variable resistance element of an integrating circuit which comprises the variable resistance, a integration capacitance and an amplifier. The method is achieved by injecting electric charge into the integration capacitance based on a first time constant determined based on the resistance value of the variable resistance and a capacitance value of the capacitance; by switching a connection to the amplifier from the variable resistance element to switched capacitor; by ejecting the electric charge stored in the capacitance based on a second time constant determined based on the capacitance value of the switched capacitor and the capacitance value of the capacitance; and by setting the resistance value of the variable resistance based on a voltage of the capacitance element after the electric charge is ejected.

In a time constant adjusting circuit according to the present invention, by using a switched capacitor, sufficient accuracy is maintained even in a state that a time constant generating circuit is incorporated in an integrated circuit. A storage section for storing a correction result of the time constant is further arranged so that the time constant adjusting circuit and a normal operation circuit after time constant adjustment can be partially used in common. The number of terminals of the integrated circuit and an area of a semiconductor chip can be saved, and it is therefore possible to suppress a manufacturing cost. Furthermore, as long as a power supply is supplied from the outside, the time constant can be adjusted automatically and autonomously.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram schematically showing a configuration of a conventional time constant adjusting circuit;

FIG. 2 is a circuit diagram showing a specific configuration of the conventional time constant adjusting circuit;

FIG. 3 is a circuit diagram showing the configuration of another time constant adjusting circuit;

FIG. 4 is a block diagram schematically showing an entire configuration of an electronic circuit which uses a time constant adjusting circuit according to an embodiment of the present invention;

FIG. 5 is a block diagram schematically showing a configuration of the time constant adjusting circuit according to the embodiment of the present invention;

FIG. 6 is a circuit diagram showing a specific configuration of the time constant adjusting circuit according to the embodiment of the present invention;

FIG. 7 is a circuit diagram showing a configuration of the time constant adjusting circuit according to the embodiment of the present invention, in which a flip-flop section is added;

FIG. 8 shows time charts of signals observed when a time constant adjustment mode is executed according to the embodiment of the present invention;

FIG. 9 is a circuit diagram showing an integration circuit using a switched capacitor;

FIG. 10A is a diagram showing a consecutive time signal processing configuration in an integrating circuit using a resistance;

FIG. 10B is a diagram showing a discrete time signal processing configuration in the integrating circuit using a switched capacitor; and

FIG. 11 shows time charts of signals observed when the time constant adjustment mode according to the present invention is executed.

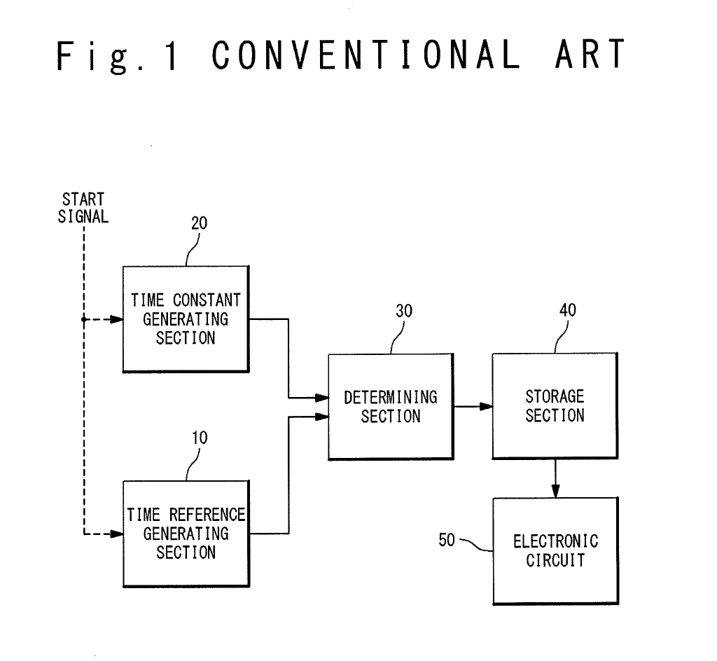

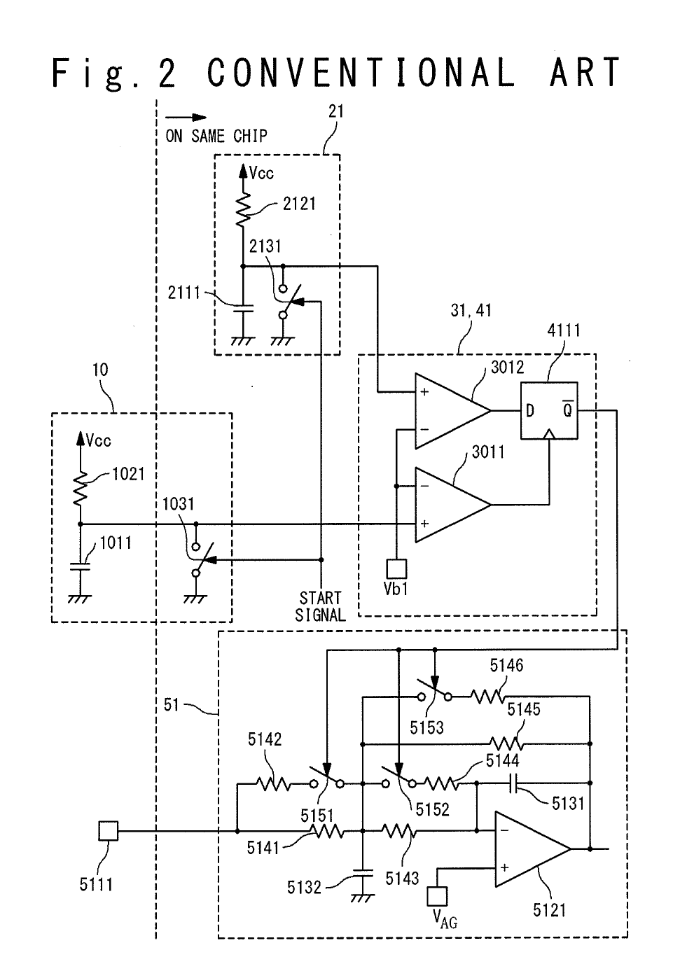

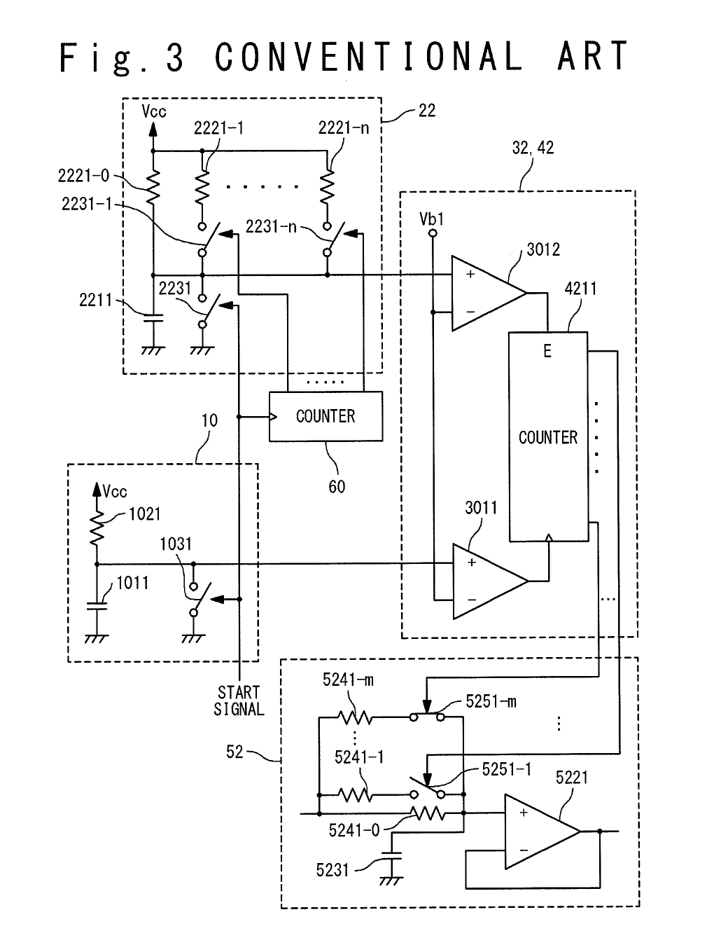

### DETAILED DESCRIPTION

Hereinafter, a time constant adjusting circuit serving realized as a semiconductor integrated circuit according to the present invention will be described below with reference to attached drawings.

### First Embodiment

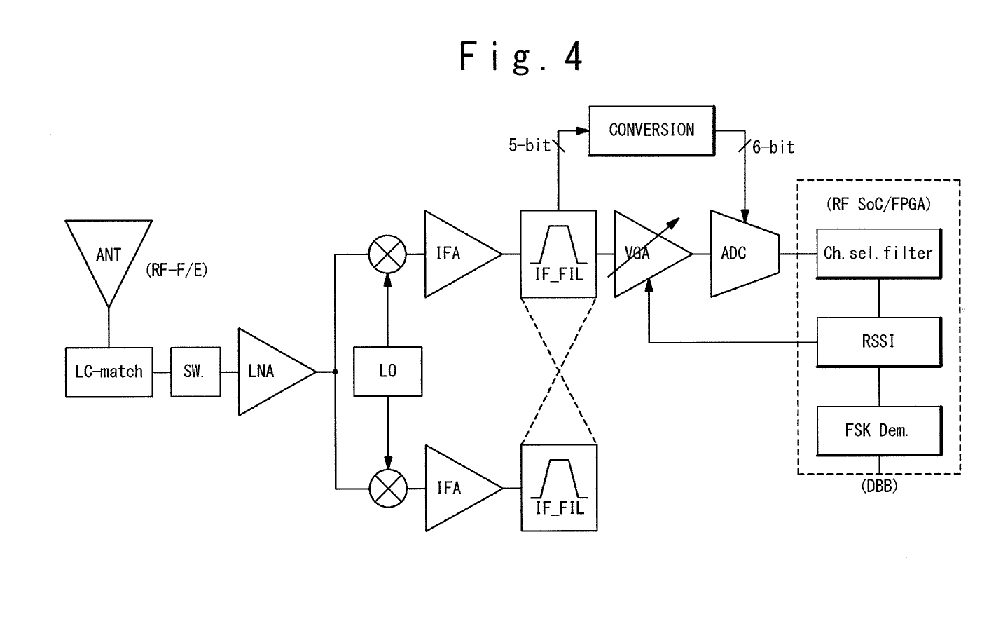

FIG. 4 is a block diagram schematically showing a configuration of an electronic circuit which uses the time constant adjusting circuit according to a first embodiment of the present invention. The electronic circuit is provided with an antenna section (ANT), a low noise amplifier circuit section (LNA), mixer circuit sections, complex band-pass filter sections (IF_FIL), a variable gain amplifier circuit section (VGA), an analog-to-digital converter (ADC), and a digital baseband circuit section (DBB).

A radio signal is received by the antenna (ANT) through an LC impedance matching circuit (LC-match). The low noise amplifier circuit section (LNA) is arranged at a rear stage of the antenna section ANT, and the received signal is supplied to the low noise amplifier circuit section (LNA) through a switch (SW) and amplified by it. Each of the mixer circuit sections is arranged at a rear stage of the low noise amplifier circuit section (LNA). Orthogonal signals are generated by an oscillator (Lo) and supplied to the mixer circuit sections. The mixer circuit section includes an amplifier (IFA) for an intermediate frequency band. The complex band-pass filter sections (IF_FIL) are arranged at rear stages of the mixer circuit sections, respectively. The complex band-pass filter sections (IF_FIL) are connected to each other. 5-bit data used for adjusting a filtering function is supplied from the filter section (IF_FIL) to a conversion table. The variable gain amplifier circuit section VGA is arranged at a rear stage of one of the complex band-pass filter sections (IF_FIL). The analog-to-digital converter (ADC) is arranged at a rear stage of the variable gain amplifier circuit section (VGA). The analog-to-digital converter (ADC) receives 6-bit data from the conversion table in response to the 5-bit data, and performs on A/D conversion on the output of the amplifier (VGA). The digital baseband circuit section (DBB) is arranged at a rear stage of the analog-to-digital converter ADC. The digital baseband circuit section (DBB) is also connected to the variable gain amplifier circuit section (VGA).

The antenna section (ANT) receives a high frequency signal. The low noise amplifier circuit section (LNA) amplifies the high frequency signal. The orthogonal signals are generated by the oscillator (Lo) and supplied to the mixer circuit sections. The mixer circuit section mixes the orthogonal signal and the output of the amplifier (LNA), and converts the amplified high frequency signal into an intermediate frequency signal. The mixer circuit section includes the amplifier (IFA) which amplifies the intermediate frequency signal. The complex band-pass filter sections (IF_FIL) applies a filtering function to the amplified intermediate frequency signal by using 5-bit correction data, which is supplied to the conversion table. The variable gain amplifier circuit section VGA performs a gain control on the intermediate frequency signal. The analog-to-digital converter (ADC) carries out analog-to-digital conversion to the intermediate frequency signal which has been subjected to the gain control, by using the 6-bit correction data. The digital baseband circuit section (DBB) demodulates a signal which has been subjected to the analog-to-digital conversion, removes a proximate interference wave, and carries out feedback gain adjustment to the variable gain amplifier circuit section (VGA).

In the electronic circuit shown in FIG. 4, a time constant adjusting circuit is included in the complex band-pass filter section (IF_FIL). In a conventional technique, the time constant adjusting circuit searches resistance value correction data by a microcomputer, and the analog-to-digital converter ADC receives a correction result as correction data of a capacitance value. In the conventional technique, the correction data is searched and stored by the microcomputer, whereas in the present invention, the microcomputer is not required because the time constant adjusting circuit carries out self-search of the correction data. In the present invention, a register is separately provided to hold the search result of the correction data, so that the analog-to-digital converter (ADC) can be used as a single unit.

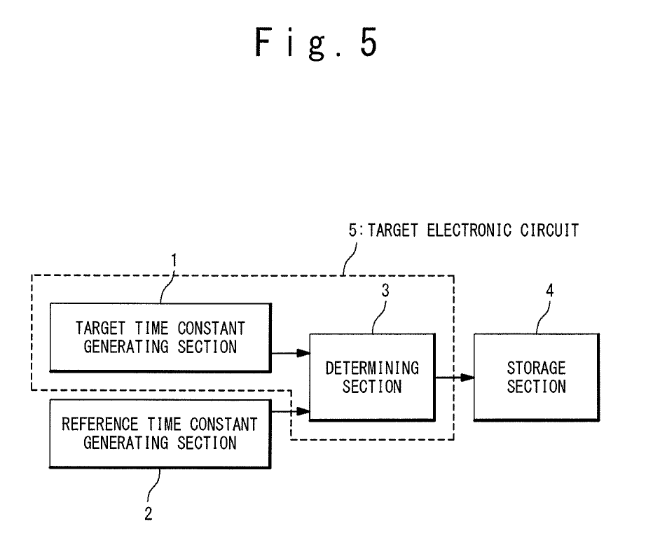

FIG. 5 is a block diagram schematically showing a configuration of the time constant adjusting circuit in a first embodiment of the present invention. The time constant adjusting circuit shown in FIG. 5 is provided with a target time constant generating section 1 serving as an adjusting circuit, a reference time constant generating section 2 which is a switched capacitor, a determining section 3, a storage section 4, and a target electronic circuit 5 serving as an integrating circuit. It should be noted that the target electronic circuit 5 is provided over the target time constant generating section 1 and the determining section 3.

A connection relation between the sections in the time constant adjusting circuit in FIG. 5 will be described. The target time constant generating section 1 and the reference time constant generating section 2 are connected to the determining section 3. The determining section 3 is connected to the storage section 4.

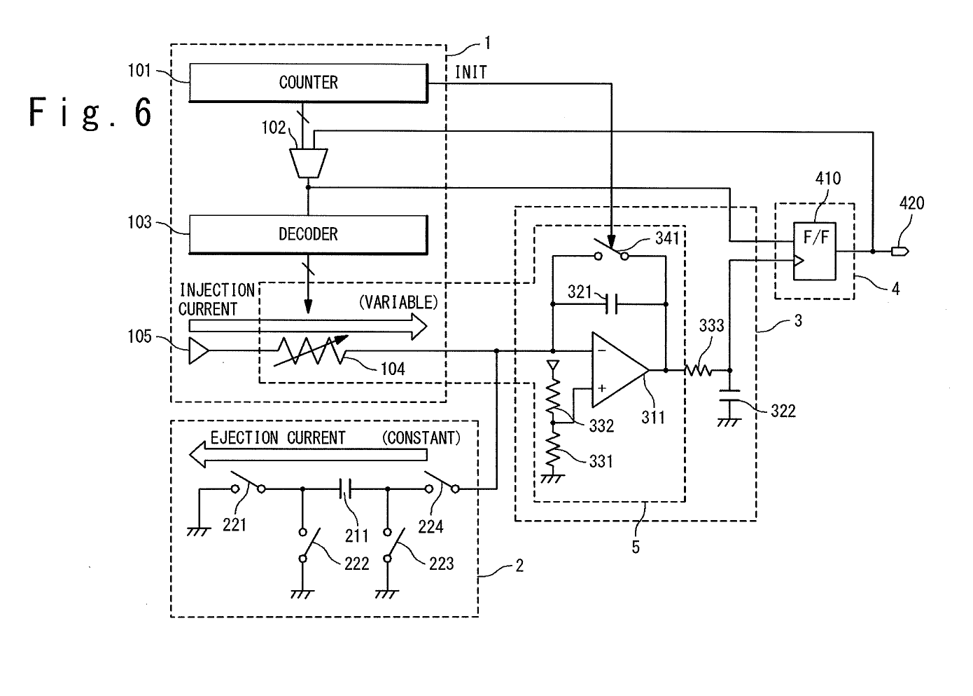

FIG. 6 is a circuit diagram showing a specific configuration of the time constant adjusting circuit according to the first embodiment of the present invention. Similar to that of FIG. 5, the time constant adjusting circuit of FIG. 6 is provided with the target time constant generating section 1, the reference time constant generating section 2, the determining section 3 and the storage section 4. The target time constant generating section 1 includes a counter 101, a selecting circuit 102, a decoder 103, a variable resistance 104, and an input node 105. The reference time constant generating section 2 is a switched capacitor which includes a capacitance 211 and four switches 221 to 224. The determining section 3 includes an amplifier 311, an integration capacitance 321, a capacitance 322, three resistances 331 to 333, and a switch 341. The storage section 4 includes a flip-flop section 410 and a correction result output node 420.

A connection relation between the components in the time constant adjusting circuit of FIG. 6 will be described. The counter 101 is connected to a first input of the selector. The counter 101 is also connected to the switch 341. The selecting circuit 102 is connected to the decoder 103 and the flip-flop section 410. The decoder 103 is connected to the variable resistance 104. One end of the variable resistance 104 is connected to the input node 105. The other end of the variable resistance 104 is connected to an inversion input of the amplifier 311, one end of the switch 341, one end of the integration capacitance 321, and one end of the switch 224.

The other end of the switch 224 is connected to one end of the capacitance 211 and one end of the switch 223. The other end of the switch 223 is grounded. The other end of the capacitance 211 is connected to one end of the switch 221 and one end of the switch 222. The other end of the switch 221 is grounded. The other end of the switch 222 is grounded.

A non-inversion input of the amplifier 311 is connected to a connection node between two resistances 331 and 332. The other end of the resistance 331 is grounded. The other end of the resistance 332 is connected to a power supply voltage. An output of the amplifier 311 is connected to the other end of the switch 341, the other end of the integration capacitance 321, and one end of the resistance 333. The other end of the resistance 333 is connected to one end of the capacitance 322, and the flip-flop section 410. The other end of the capacitance 322 is grounded.

An output of the flip-flop section 410 is connected to the output node 420 and the selecting circuit 102.

An operation of the time constant adjusting circuit shown in FIG. 6 according to the present invention will be described. The time constant adjusting circuit according to the present invention has a time constant adjustment mode and a normal operation mode. In the start of the operation, the time constant adjusting circuit operates in the time constant adjustment mode. When the time constant adjustment mode is ended, the operation mode is changed to the normal operation mode.

The time constant adjustment mode in the time constant adjusting circuit according to the present invention will be described. In the time constant adjustment mode, firstly, the counter 101 starts a counting operation, and outputs a counter output signal indicating a count value to the selecting circuit 102. The selecting circuit 102 selects the counter output signal from the counter 101 and outputs it to the decoder 103. The decoder 103 generates a decoder output signal based on the counter output signal outputted from the selecting circuit 102. The decoder output signal is supplied to the variable resistance 104. A resistance value R of the variable resistance 104 is switched in accordance with the decoder output signal from the decoder 103. Therefore, a time constant RC is changed which is determined based on a resistance value R of the variable resistance 104 and a capacitance value C of the integration capacitance 321. It should be noted that, at this point, a value of the time constant RC is merely represented by a temporary signal.

The counter 101 activates an initialization signal INIT every time to output the counter output signal of the count value, and the initialization signal INIT is outputted to the switch 341. When the initialization signal INIT is activated, the switch 341 is closed. When the switch 341 is closed, the integration capacitance 321 discharges. Every time the integration capacitance 321 discharges, an integrated value is reset.

An integrating operation for a count is continued for a period that is long enough to compare time constants. The length of the period is desirably about 10 times the time constant.

A resistance value of the variable resistance 104 is increased in accordance with the count and therefore exceeds an equivalent resistance value corresponding to the switched capacitor at a time during the period. At this time, in the inversion input of the amplifier 311, a relation is inverted between a current supplied from the target time constant generating section 1 and a current ejected by the reference time constant generating section 2 and, as a result, an output signal of the amplifier 311 is inverted.

When an output signal of the amplifier 311 is inverted, the inverted signal is supplied to a clock terminal of the storage section 4, and the flip-flop section 410 stores the count value from the counter 101 through the selecting circuit 102.

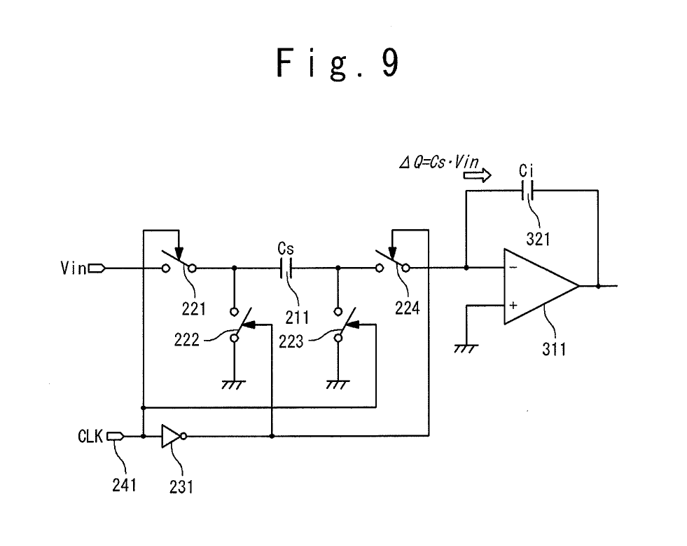

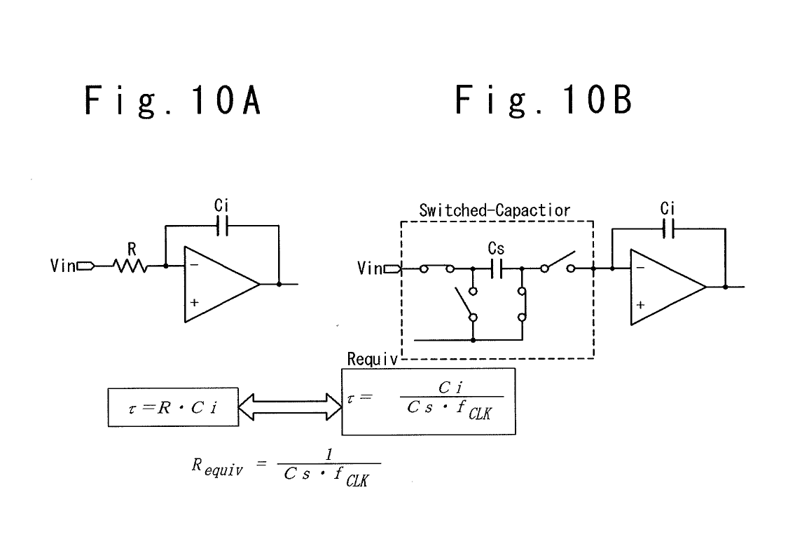

Referring to FIGS. 9 and 10, the reason why a highly accurate reference time constant can be generated by using the switched capacitor will be described in detail.

The reference time constant generating section 2 sets a target time constant by combining the integration capacitance 321 and the resistance equivalent to the switched capacitor. A principle of ideally generating the time constant by using the switched capacitor will be described.

FIG. 9 is a circuit diagram showing an integrating circuit using the switched capacitor. The integrating circuit has an amplifier 311, the capacitance 211, the integration capacitance 321, the four switches 221 to 224, a power supply voltage, a clock signal input 241, and an inverter circuit 231.

A connection relation between the components in the integrating circuit of FIG. 9 will be described. The connection relation among the amplifier 311, the capacitance 211, the integration capacitance 321 and the four switches 221 to 224 is the same as those of FIG. 6 and the description thereof will be omitted. It should be noted that the other end of the switch 221 is not grounded but connected to the power supply voltage. The clock signal node 241 is connected to the inverter circuit 231, and each of the two switches 221 and 223. The inverter circuit 231 is connected to each of the two switches 222 and 224.

An operation in the integrating circuit of FIG. 9 will be described. First, a periodical clock signal CLK is supplied from the clock signal node 241.

First of all, in a high level of the clock signal, the two switches 221 and 223 are closed and the two switches 222 and 224 are opened. At this time, the capacitance 211 of the switched capacitor is charged in accordance with the following charge:

•Q=Cs×Vin

Here, Cs is a capacitance value of the switched capacitor, and Vin is the power supply voltage.

Next, in a low level of the clock signal CLK, the two switches 221 and 223 are opened and the two switches 222 and 224 are closed. At this time, the charge •Q charged in the capacitance 211 is transferred to the integration capacitance 321.

By transferring the charge •Q, the following current flows between the capacitance 211 and the integration capacitance 321:

I=•Q×f_{CLK}=Cs×Vin×f_{CLK}

Here, f_{CLK} is a frequency of the clock signal CLK.

When the Ohm's law is applied to the current I, the following equation can be obtained:

I=Vin/R_{equiv}

Here, R_{equiv} is an equivalent resistance value corresponding to the capacitance 211 and can be expressed as follows:

R_{equiv}=1/(Cs×f_{CLK})

FIGS. 10A and 10B are diagrams for comparing a consecutive time signal processing configuration and a discrete time signal processing configuration in the integrator. FIG. 10A shows the consecutive time signal processing configuration in the integrating circuit using a resistance. FIG. 10B shows the discrete time signal processing configuration in the integrating circuit using the switched capacitor.

The circuit diagram of FIG. 10B is provided by simplifying the circuit diagram of FIG. 9 and detailed explanation thereof will be omitted. The circuit diagram of FIG. 10A is provided by replacing the switched capacitor in the circuit diagram of FIG. 9 with the resistance R. Accordingly, the circuit of FIG. 10A and the circuit of FIG. 10B are supposed to perform an operation to have the same characteristic.

However, in the circuit of FIG. 10A, a time constant τ is determined based on a product of the resistance R and the integration capacitance Ci. Accordingly, accuracy of the time constant τ is largely influenced by variations of the resistance R and the integration capacitance Ci. In contrast, in the circuit of FIG. 10B, the time constant τ is determined based on a ratio of a capacitance Cs of the switched capacitor and the integration capacitance Ci, and the clock signal frequency f_{CLK}. In general, elements adjacently arranged in an integrated circuit have similar variations, so that the ratio of the capacitance Cs in the switched capacitor and the integration capacitance Ci will be substantially fixed. Accordingly, in comparison with the case of FIG. 10A, the time constant τ in FIG. 10B has an endurance for the variations. That is, as long as the clock signal frequency f_{CLK} is maintained in a fixed state, the time constant τ could be fixed.

The reference time constant generating section 2 provides a highly accurate reference time constant by using the switched capacitor.

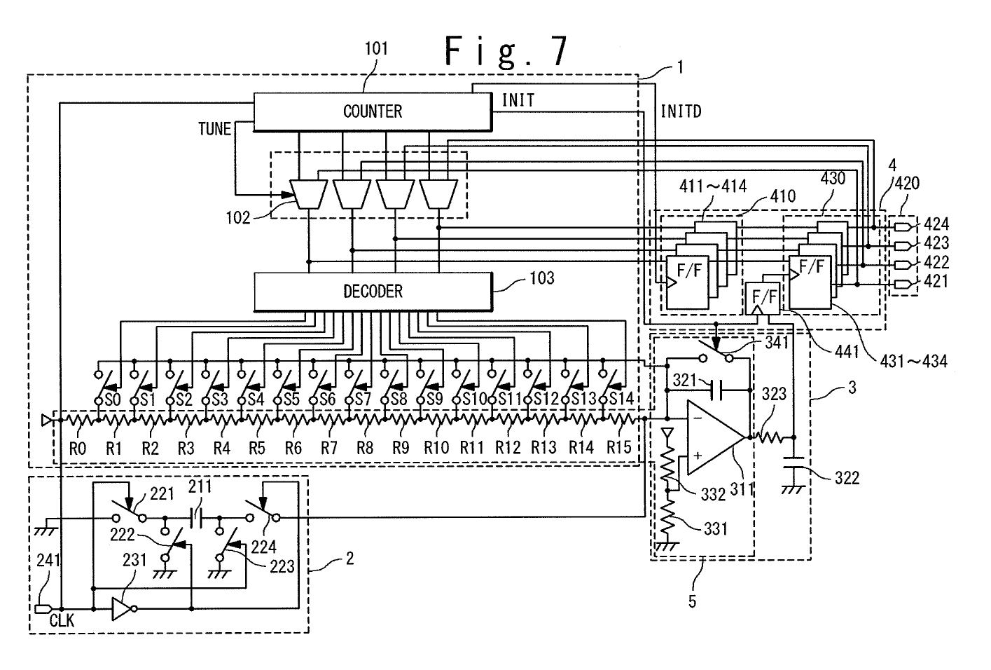

FIG. 7 is a circuit diagram showing a configuration of the time constant adjusting circuit according to the present invention, in which a flip-flop section 430 is added to the rear stage of the low-pass filters 322 and 323 and the flip-flop section 410. Other changes are added to the time constant adjusting circuit of FIG. 7 in comparison with that of FIG. 6. Here, a case of a correction data having the accuracy of 4 bits will be described.

More specifically, the counter 101 outputs a counter output signal of 4 bits indicating the count value. The selecting circuit 102 is internally provided with four selectors. The variable resistance 104 includes 16 resistance elements R0 to R15 that are connected in series. 15 switches S0 to S14 are connected to 15 connection nodes between every two of these 16 resistance elements R0 to R15, respectively. The decoder 103 receives the 4-bit counter output signal and converts it into the decoder output signal of 15 bits to control the 15 switches S0 to S14.

The storage section 4 includes the flip-flop section 410 in a front stage, a flip-flop section 430 in the rear stage, and a flip-flop 441 used for re-segmentation of the waveform. The flip-flop section 410 includes four flip-flops 411 to 414. The flip-flop section 430 includes four flip-flops 431 to 434. The correction result output node 420 includes four correction result output ends 421 to 424.

The counter 101 outputs a count value of the clock signal CLK, the first initialization signal INIT as a control signal, the second initialization signal INITD as the control signal, and a control signal TUNE which controls the selecting circuit 102. Here, the second initialization signal INITD is obtained by delaying the first initialization signal INIT by a half of the clock period. The counter 101 is not only connected to the switch 341, but also connected to the waveform re-segmentation flip-glop 441. The counter 101 is connected to a clock input of each of the four flip-flops 411 to 414 to supply the second initialization signal INITD thereto. The counter 101 is connected to each of the four selectors in the selecting circuit 102 to supply the control signal TUNE thereto.

The four selectors in the selecting circuit 102 are not only connected to the decoder 103, but also connected to the four flip-flops 411 to 414 in the flip-flop section 410, respectively. The four flip-flops 411 to 414 in the flip-flop section 410 are connected to the clock inputs of the four flip-flops 431 to 434 in the flip-flop section 430, respectively. The low-pass filter 323 and 322 is connected to the waveform re-segmentation flip-flop 441. The waveform re-segmentation flip-flop 441 is connected to clock inputs of the four flip-flops 431 to 434 in the flip-flop section 430. The four flip-flops 431 to 434 in the flip-flop section 430 are connected to the correction result output ends 421 to 424, and also connected to the four selectors in the selecting circuit 102, respectively.

The correction data is supplied from the selecting circuit 102 to the flip-flops 411 to 414 in the flip-flop section 410 and the decoder 103.

It should be noted that the accuracy of a correction data may be the optional number of bits other than 4 bits. At this time, a total number of components will be changed, depending on the accuracy of correction data.

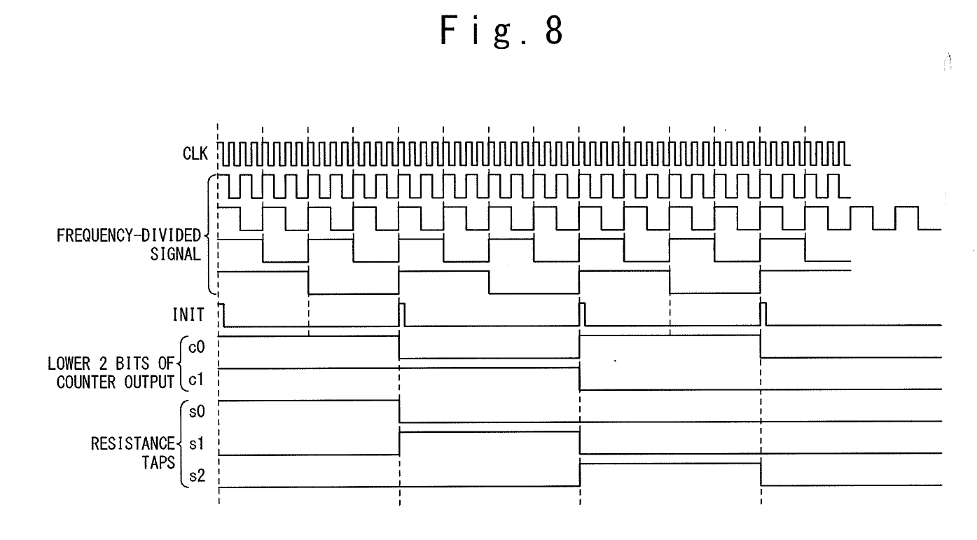

FIG. 8 shows a time chart of each of 11 signals observed in the time constant adjustment mode according to the present invention. In the time chart of FIG. 8, a horizontal axis shows time. These 11 time charts correspond to the clock signal CLK, four frequency-divided clock signals, the first initialization signal INIT, lower 2 bits (c0 and c1) of 4 bits of the counter output signal, and waveforms of three tap switching (s0, s1 and s2) of 15 tap switches S0 to S14, from the top.

The clock signal CLK which is supplied from an external unit has a frequency f_{CLK}.

The counter 101 receives the clock signal CLK, and after carrying out frequency division of 4 stages in this example, outputs the first initialization signal INIT and the counter output signal. More specifically, in this example, the first initialization signal INIT is set to a high level only for one cycle of the clock signal CLK once per a period of 16 cycles of the clock signal CLK, and maintained in a low level in the remaining period of time. The least significant bit C0 of the counter output signal outputted from the counter 101 is also switched between a high level and a low level for every period of 16 cycles of the clock signal CLK.

The upper bits of the counter output signal outputted from the counter 101 are switched between a high level and a low level for every period of 32 cycles, 64 cycles or 128 cycles of the clock signal CLK.

In response to the counter output signal outputted from the counter 101, the decoder 103 outputs the decoder output signal of 15 bits to control the 15 switches S0 to S14, respectively. Here, of the 15 bits of the decoder output signal, only one bit is set to the high level and the remaining bits are all maintained in the low level. That is, only one of the 15 switches S0 to S14 is closed and the remaining switches are all opened. Here, the closed switch corresponds to the counter output signal outputted from the counter 101. More specifically, as the count increases in the counter 101, the switches from the first switch S0 to the fifteenth switch S14 are closed in this order.

As described above, every time the count value is switched, the first initialization signal INIT is set to the high level and an integrated value is reset. In this example, it is understood that a period of time equal to or more than 10 times the time constant elapses until a next integrated value is reset after the integrated value is reset.

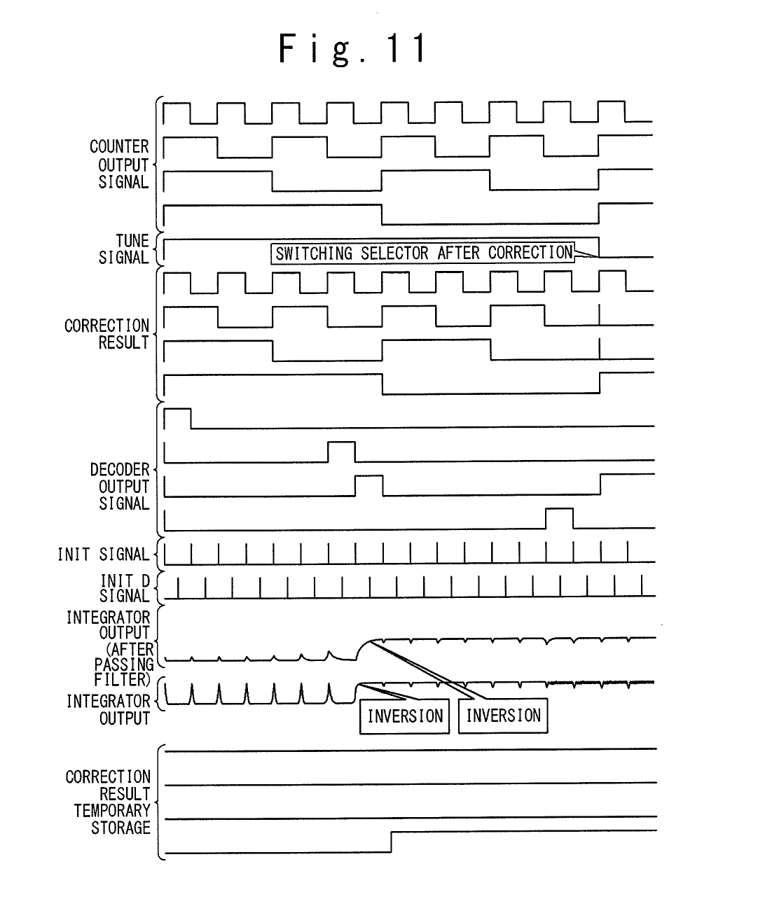

FIG. 11 shows time charts of signals observed when the time constant adjustment mode according to the present invention is executed in more detailed. In FIG. 11, a horizontal axis shows time. FIG. 11 shows time charts for a total of 9 signals. The time charts for the 9 signals corresponds to the counter output signal of 4 bits, the control signal TUNE, a correction result of 4 bits, the decoder output signal of first, seventh, eighth and fifteenth bits of 16 bits outputted from the decoder 103, the first initialization signal INIT, the second initialization signal INITD, an integrator output signal after filter transmission, the integrator output signal before the filter transmission, and a temporary signal for the correction result of 4 bits.

It should be noted that the counter output signal of 4 bits shown in FIG. 11 correspond to first to fourth bits. Of the 4 bits of the counter output signal of FIG. 11, the first and second bits of the counter output signal are the same as those of the lower 2 bits shown in FIG. 8.

As described above, when the resistance value R of the variable resistance 104 exceeds an equivalent resistance value corresponding to the switched capacitor in the reference time constant generating section 2, an output from the determining section 3 is inverted from the low level to the high level. In the example of FIG. 11, while the eighth bit of the decoder output signal is in the high level, the integrator output signal is inverted. That is, while the first to seventh bits of the decoder output signal are in the high level, the integrator output signal are in the low level, whereas while the eighth to sixteenth bits thereof are in the high level, the integrator output signal is in the low level. This inversion signal is used as a rising edge for the storage section 4 and the count value at that time is stored in the four flip-flops 411 to 414 as correction data.

At this time, a high frequency component of a determination signal outputted from the determining section 3 is removed by the low-pass filter connected to the rear stage of the determining section 3. As a result, a signal received by the storage section 4 shows a sharp rising waveform unlike the integrator output signal after filter transmission in FIG. 11.

Operations of the flip-flop sections 410 and 430 to latch the counter output signal will be described in detail. Firstly, 4 bits of the counter output signal outputted from the selecting circuit 102 is stored in the four flip-flops 411 to 414 in the flip-flop section 410, respectively. It should be noted that the second initialization signal INITD is supplied to the clock input of each of the four flip-flops 411 to 414. Accordingly, the four flip-flops 411 to 414 operate with a delay of a half cycle to the first initialization signal INIT.

Next, the 4 bits of the counter output signal stored in the four flip-flops 411 to 414 in the flip-flop section 410 are supplied to the four flip-flops 431 to 434 in the flip-flop section 430, respectively. Here, a signal outputted from the waveform re-segmentation flip-flop 441 is supplied to the clock input of each of the four flip-flops 431 to 434. Furthermore, the first initialization signal INIT is supplied to the clock input of the waveform re-segmentation flip-flop 441. Accordingly, the four flip-flops 431 to 434 operate with a further half-cycle delay to the four flip-flops 411 to 414 or operate in synchronization with the first initialization signal INIT.

By providing these two half-cycle delays, the four flip-flops 431 to 434 can surely latch the counter output signal at timing at which the integrator output signal obtained after filter transmission is set to a high level.

It should be noted that if the flip-flop section is provided only for one stage and operates in synchronization with the first initialization signal INIT, the counter output signal is latched at timing at which the counter output signal changes, so that there is a risk that an operation becomes unstable.

When the correction data is stored in the storage section 4, the time constant adjustment mode is ended. When the time constant adjustment mode is ended, the time constant adjusting circuit according to the present invention is automatically switched to the normal operation mode. In FIG. 11, at this time, the control signal TUNE is switched to the low level from the high level. The time constant adjustment mode requires only several tens of μ seconds for a general purpose.

The normal operation mode in the time constant adjusting circuit according to the present invention will be described. The adjustment is performed only once when a power supply of the time constant adjusting circuit is turned on, and the correction data stored in the storage section 4 is maintained continuously without any change unless the power supply of the time constant adjusting circuit is turned off. During that period, the storage section 4 supplies the correction data to the selecting circuit 102. The correction data is converted into the decoder output signal through the decoder 103. The decoder output signal is supplied to the variable resistance 104. A resistance value of the variable resistance 104 is corrected to the correction data obtained in the time constant adjustment mode in accordance with the decoder output signal.

If a non-volatile flash memory is further arranged to store the correction data, it is sufficient to apply the time constant adjustment mode only once in shipment of the time constant adjusting circuit.

According to the present invention, a resistance and an integrator in a ••ADC low-pass filter section of a consecutive time type can be diverted in the time constant adjustment mode. Accordingly, an additionally required component is only a small-scale digital circuit block such as the counter 101, the decoder 103 and the flip-flop section 410. In other words, in the time constant adjusting circuit according to the present invention, it is unnecessary to add a large-scale circuit block for only the purpose of time constant adjustment.

It should be noted that in the above description, the time constant adjusting circuit according to the present invention is included in the complex band-pass filter section IF_FIL in the electronic circuit of FIG. 4. However, this is merely an example and applications of the time constant adjusting circuit in the present embodiment are not limited to the above example.

In the time constant adjusting circuit according to the present invention, as a circuit to generate a time constant as a reference, the reference time constant generating section 2 can be incorporated in the integrated circuit. This is because sufficiently high accuracy of the reference time constant can be sustained by using the switched capacitor even if the reference time constant generating section 2 is provided on an integrated circuit. As a result, in comparison with a case where the reference time constant generating section needs to be arranged outside the integrated circuit, not only terminals for connection can be saved but also variations of the time constant can be adjusted automatically and autonomously, as long as a power supply is supplied from an external unit to an integrated circuit.

In addition, in the time constant adjusting circuit according to the present invention, a plurality of resistances, a plurality of switches and counters required can be shared in both of the time constant adjustment mode and the normal operation mode after the time constant adjustment. This shared use of the components is realized by providing the storage section, and even with the storage section, a layout area of the integrated circuit can be substantially reduced.

Furthermore, the reference time constant generating section can be formed in the integrated circuit to serve as a switched capacitor using a master clock signal. That is, it is unnecessary to prepare the reference time constant generating section outside of the integrated circuit, so that the number of terminals in the integrated circuit can be saved accordingly.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A semiconductor integrated circuit comprising:
an integrating circuit comprising a variable resistance, an integration capacitance and an amplifier;
a switched capacitor connected with said amplifier in parallel to said variable resistance; and
an adjusting circuit configured to adjust a resistance value of said variable resistance,
wherein said integrating circuit generates a control signal of a voltage based on a first time constant determined based on the resistance value of said variable resistance and a capacitance value of said integration capacitance, and a second time constant determined based on a capacitance value of said switched capacitor and the capacitance value of said integration capacitance, and
wherein said adjusting circuit adjusts the resistance value of said variable resistance based on said control signal.

2. The semiconductor integrated circuit according to claim 1, wherein said adjusting circuit comprises a counter configured to control the resistance value,
wherein said integrator circuit comprises:
a determining section configured to determine a relation of said first time constant and said second time constant to output the control signal; and
a storage section configured to store a correction result of said variable resistance value in response to the control signal.

3. The semiconductor integrated circuit according to claim 2, wherein said adjusting circuit further comprising:
a selecting circuit arranged in a front stage to said variable resistance and configured to output one of a counter output signal of said counter or said correction result stored in said storage section.

4. The semiconductor integrated circuit according to claim 3, wherein said adjusting circuit further comprising:
a switch configured to switch the resistance value of said variable resistance in response to a selector output signal from said selector; and
a decoder configured to convert an output signal of said selecting circuit into a signal to control said switch.

5. The semiconductor integrated circuit according to claim 2, wherein said storage section comprises a non-volatile flash memory.

6. A method of adjusting a resistance value of a variable resistance element of an integrating circuit which comprises the variable resistance, a integration capacitance and an amplifier, the method comprising:
injecting electric charge into said integration capacitance based on a first time constant determined based on the resistance value of said variable resistance and a capacitance value of said capacitance;
switching a connection to said amplifier from said variable resistance element to switched capacitor;
ejecting the electric charge stored in said capacitance based on a second time constant determined based on the capacitance value of said switched capacitor and said capacitance value of said capacitance; and
setting the resistance value of said variable resistance based on a voltage of said capacitance element after the electric charge is ejected.

7. The method according to claim 6, wherein said step setting comprises:
generating a control signal when a polarity of the voltage of said capacitance element is inverted;
storing a correction result in a storage unit in response to the control signal; and
adjusting the variable resistance value of said variable resistance element until the correction result is stored.
